(19) United States
(12) Patent Application Publication
(10) Pub. No.: US 2014/0227015 A1
(43) Pub. Date: Aug. 14, 2014

(54) FIXING MEMBER TO FACILITATE ELECTROPHOTOGRAPHY

(71) Applicant: Samsung Electronics Co., Ltd., Suwon-si (KR)

(72) Inventors: Sun-hyung LEE, Yangyang-gun (KR); Ju-hyeong LEE, Busan (KR); Sang-uk JEON, Yongin-si (KR)

(73) Assignee: Samsung Electronics Co., Ltd., Suwon-si (KR)

(21) Appl. No.: 13/946,367

(22) Filed: Jul. 19, 2013

(30) Foreign Application Priority Data
Feb. 12, 2013 (KR) 10-2013-0014975

(51) Int. Cl. G03G 15/20

(52) U.S. Cl. CPC G03G 15/2075
USPC 399/333

(57) ABSTRACT

A fixing member has a releasing layer that includes a releasing layer material. A method of manufacturing the fixing member having the releasing layer includes the releasing layer material. The releasing layer includes a monomolecular layer of organic silane-based compounds.

### CROSS-REFERENCE TO RELATED APPLICATIONS

This application claims priority under 35 U.S.C. §119(a) from Korean Patent Application No. 10-2013-0014975, filed on Feb. 12, 2013, in the Korean Intellectual Property Office, the entire disclosure of which is incorporated herein in its entirety by reference.

### BACKGROUND

1. Field

The present general inventive concept relates to electrophotography, and particularly to a fixing member for electrophotography, and more particularly to a fixing member having a releasing layer.

2. Description of the Related Art

Fixing devices in image forming devices using an electrophotographic method such as photocopiers, printers, facsimiles generally include fixing a roller (or fixing belt) and a pressure roller (or pressure belt). While a recording paper with a transferred unfixed toner image passes between a fixing roller (or, a fixing belt) and a pressure roller (or a pressure belt), heat and pressure are applied to the unfixed toner image by the fixing roller and the pressure roller, and a heated and pressured toner image is fixed on the recording paper. Members of a fixing apparatus participating in fixing the toner image, for example, a fixing roller, a fixing belt, a pressure roller, and a pressure belt are commonly referred to as fixing members.

A releasing layer is formed on a surface of a fixing member. The releasing layer prevents a “toner offset”. The “toner offset” used herein refers to a phenomenon in which at least a portion of the unfixed toner image is separated from the recording paper and becomes fixed on a surface of the fixing belt or the fixing roller, as the recording paper passes through a nip portion formed by an engaged rotation of the fixing roller (or the fixing belt) and the pressure roller (or the pressure belt). The releasing layer may also prevent the recording paper from being wound around the fixing member. The fixing member includes a heating apparatus that generates heat to heat the unfixed toner image. The releasing layer is exposed to heat and pressure. It is preferable that the releasing layer has releasability as well as heat-resistability and anti-abrasiveness.

Materials of the releasing layer include, for example, silicon resin, fluorine resin, silicon rubber, fluorine rubber, and the like. Specifically, the fluorine resin is most commonly used due to its releasability and anti-abrasiveness. As the fluorine resin, for example, perfluoroalkoxy resin (PFA), polytetrafluoroethylene (PTFE), fluorinated ethylene propylene polymer resin (FEP resin) or the like may be used.

In general, the releasing layer may be manufactured in a tube form and fixed on the surface of the fixing member. In other embodiments, the releasing layer may be formed by coating a releasing layer material on the surface of the fixing member. A method of preparing the releasing layer and the releasing layer material may vary depending on a material of the fixing member supporting the releasing layer. The fixing member may be prepared from a metal, a resin, or a rubber. When bonding strength between the fixing member and the releasing layer is weak, a bonding layer is interposed between the surface of the fixing member and the releasing layer.

### SUMMARY

The present general inventive concept provides a fixing member having a releasing layer including a an effective releasing layer material. A bonding layer may be disposed between the releasing layer and the fixing member. The bonding layer has effective heat resistance. Also, the bonding layer has effective chemical stability against both the releasing layer and the fixing member. Also, when the releasing layer is formed by coating, a uniform and flat releasing layer is obtained. In addition, a strong chemical bond between a coated releasing layer and the fixing member is obtained without requiring special equipment to coat the releasing layer.

Additional features and utilities of the present general inventive concept will be set forth in part in the description which follows and, in part, will be obvious from the description, or may be learned by practice of the general inventive concept.

The present general inventive concept also provides a fixing device including a fixing member, wherein the fixing member has a releasing layer including the effective releasing layer material.

The present general inventive concept also provides an image forming apparatus having a fixing device including a fixing member having a releasing layer, wherein the releasing layer includes the effective releasing layer material.

Exemplary embodiments of the present general inventive concept may include a fixing member that includes a fixing member body having a surface, and a releasing layer fixed on the surface, wherein the releasing layer includes a monomolecular layer derived from an organic silane-based compound having a lipophilic organic group at one end and a hydrolysis-polymerizable functional group at another end, wherein the monomolecular layer is covalently bonded to the surface by the hydrolysis-polymerizable functional group.

The lipophilic organic group may include hydrophobic groups. For example, the lipophilic organic group may include at least one of —CH₃ and —CF₃.

The hydrolysis-polymerizable functional group may include a hydroxyl group, a halogen atom, or an alkoxy group.

The organic silane-based compound may be represented by SiR¹R²R³X (Formula 1) wherein R¹ is a substituted or unsubstituted C₁-C₁₂ alkyl group, a substituted or unsubstituted C₂-C₁₂ alkenyl group, a substituted or unsubstituted C₂-C₁₂ alkynyl group, or a substituted or unsubstituted C₆-C₁₂ aryl group, R² is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or a C₁-C₃ alkoxy group, R³ is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or, C₁-C₃ alkoxy group, and X is a hydroxyl group, a halogen atom, or a C₁-C₃ alkoxy group.

At least one of R² and R³, which are substituents of an organic silane-based compound represented by Formula 1, may be a hydrolysis-polymerizable functional group.

The releasing layer may include a plurality of monomolecular layers of organic silane-based compounds.

The fixing member may further include a heat unit.

The surface of the fixing member body may be a hydroxyl group-forming material.

The Si atom of the organic silane-based compound represented by Formula 1 may have at least two substituents R¹ and X, when R² and R³ of Formula 1 are hydrogen atoms.

The Si atom of the organic silane-based compound represented by Formula 1 may have four substituents R¹, R², R³, and X, when substituents R² and R³ of Formula 1 are not hydrogen atoms.

The substituent X may be bonded to the surface of the fixing member to form an —O— bond, and at least one Si atom of the organic silane-based compound represented by Formula 1 may be fixed on a substrate through a Si—O-substrate bond.

A hydrophobic group may be located at a distal end of at least one of substituents R² and R³ of Formula 1.

At least one of substituents R² and R³ of Formula 1 may form an —O— bond, and at least a first Si-atom of a first molecule of the organic silane-based compound represented by Formula 1 may connect to another Si atom of a second proximate molecule of the organic silane-based compound via a Si—O—Si bond.

Exemplary embodiments of the present general inventive concept may include a fixing device that includes a fixing roller or a fixing belt; and a pressure roller or a pressure belt that is arranged to rotate through engagement with the fixing roller or the fixing belt, wherein at least one of the fixing roller, the fixing belt, the pressure roller, and the pressure belt includes a fixing member provided according to an embodiment of the present general inventive concept.

Exemplary embodiments of the present general inventive concept may include an image forming apparatus that includes a fixing device having a fixing roller or a fixing belt, and a pressure roller or a pressure belt arranged to rotate through engagement with the fixing roller or the fixing belt, wherein at least one of the fixing roller, the fixing belt, the pressure roller, and the pressure belt includes a fixing member provided according to an embodiment of the present general inventive concept.

Exemplary embodiments of the present general inventive concept may include a method of preparing a fixing member, including introducing hydroxyl groups to a surface of a fixing member body; and bonding an organic silane-based compound to the hydroxyl groups of the surface of the fixing member body to form a releasing layer of the fixing member body, wherein the releasing layer includes a monomolecular layer derived from an organic silane-based compound having a lipophilic organic group at one end and a hydrolysis-polymerizable functional group at another end, wherein the monomolecular layer is covalently bonded to the surface by the hydrolysis-polymerizable functional group.

The organic silane-based compound may be represented by Formula 1, which includes SiR¹R²R³X, wherein R¹ is a substituted or unsubstituted C₁-C₁₂ alkyl group, a substituted or unsubstituted C₂-C₁₂ alkenyl group, a substituted or unsubstituted C₂-C₁₂ alkynyl group, or a substituted or unsubstituted C₆-C₁₂ aryl group, R² is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or a C₁-C₃ alkoxy group, R³ is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or, C₁-C₃ alkoxy group, and X is a hydroxyl group, a halogen atom, or a C₁-C₃ alkoxy group.

Introducing hydroxyl groups to the surface of the fixing member body may include one of treating the surface of the fixing member body with one of ozone, hydroxide, and a mixture of ozone and hydroxide, and irradiating vacuum ultraviolet (VUV) towards the surface of the fixing member body to produce oxygen free radicals and hydroxides from oxygen molecules and water molecules in an atmosphere, where the ozone and hydroxides chemically react with the surface of the fixing member body to introduce hydroxyl groups thereto.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a result obtained by measuring a water contact angle of perfluoroalkoxy (PFA) commonly used in a conventional releasing layer;

FIG. 2 illustrates a water contact angle of a surface of an untreated glass substrate;

FIG. 3 illustrates a water contact angle of a surface of a glass substrate in which hydroxyl groups are introduced;

FIG. 4 illustrates a water contact angle of a surface of a FAS-17 monomolecular layer formed on a surface of a glass substrate;

FIG. 5 illustrates results of XPS F1s measured by using an X-ray photoelectron spectroscopy (XPS) on a surface of an untreated glass substrate and a surface of a FAS-17 monomolecular layer formed on a glass substrate;

FIG. 6 illustrates results of XPS C1s measured on a surface of a FAS-17 monomolecular layer formed on a surface of a glass substrate and an untreated glass substrate;

FIG. 7 illustrates results of atomic force microscope (AFM) analysis of a surface of an untreated glass substrate;

FIG. 8 illustrates results of atomic force microscope (AFM) analysis measured on a surface of a FAS-17 monomolecular layer formed on a glass substrate;

FIG. 9 illustrates in image forming apparatus having a fixing device that includes a fixing member in accordance with exemplary embodiments of the present general inventive concept;

FIG. 10 illustrates a fixing member having a releasing layer fixed thereto, and where desired, a heating unit, in accordance with embodiments of the present general inventive concept; and

FIG. 11 is a flowchart illustrating a method of preparing a fixing member according to exemplary embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

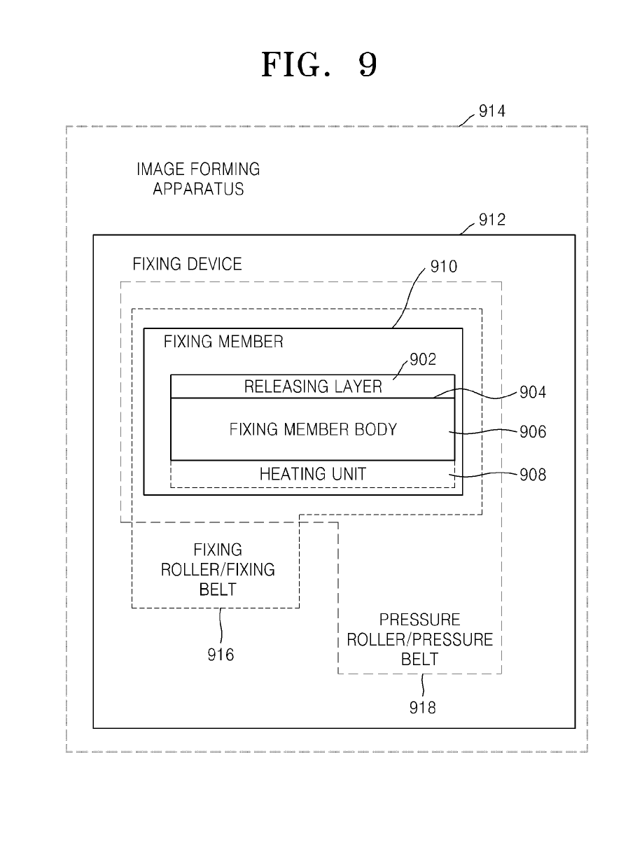

FIG. 9 illustrates an image fixing apparatus 914 including a fixing device 912 having a fixing member 910 in accordance with exemplary embodiments of the present general inventive concept. The fixing member 910 according to an embodiment of the present general inventive concept may include,a fixing member body 906 having a surface 904 and a releasing layer 902 fixed on the surface, wherein the releasing layer 902 includes a monomolecular layer derived from an organic silane-based compound, the organic silane-based compound has a lipophilic organic group at one end and a hydrolysis-polymerizable functional group at another end, and the monomolecular layer is covalently bonded to the surface by the hydrolysis-polymerizable functional group. Where desired, a heating unit 908 may provide heat to the fixing member body 906. The fixing device 912 may include a fixing roller/a fixing roller belt 916 and a pressure roller/a pressure belt 918, wherein at least one of the fixing roller/the fixing belt 916 and the pressure roller/the pressure belt 918 may include the fixing member 910. An image forming apparatus 914 may include the fixing device 912 (see below).

The fixing member body 904 may be in a form of, for example, a fixing roller, a fixing belt, a pressure roller, or a pressure belt. The fixing member body 904 may include a heating unit 908. A surface 904 of the fixing member body 906 refers to a surface of the fixing member body 906 that is to contact a recording paper during a fixing process. FIG. 10 illustrates exemplary embodiments of a fixing member 910, where the fixing member 910 is embodied as a cylindrical roller 1000 having a releasing layer 1008 fixed thereto, and where desired, a heating unit 1006. For example, as illustrated in FIG. 10, the surface 1002 of the fixing member body 1004 may be an external circumferential surface of the cylindrical roller 1000 or an internal circumferential surface of a cylindrical belt. The surface 1002 of the fixing member body 1004 may be, for example, a metal or an elastic polymer. Materials of the surface 1002 of the fixing member body 1004 are not limited thereto, and may be any material in which hydroxyl groups may be formed. For example, a heating unit 1006, such as a thermoelectric coil within the fixing body member 1004 may provide heat. A releasing layer 1008 may be formed on the surface 1002 of the fixing member body 1004.

A lipophilic organic group of the organic silane-based compound may be, for example, a hydrophobic group such as —CH₃ and —CF₃. The monomolecular layer has a first surface and a second surface. The second surface of the monomolecular layer is bonded to the surface of the fixing member body. The lipophilic organic groups are arranged in a row on the first surface of the monomolecular layer, thereby providing effective releasability to the monomolecular layer.

A hydrolysis-polymerizable functional group of the organic silane-based compound may be, for example, a hydroxyl group, a halogen atom, or an alkoxy group. The hydrolysis-polymerizable functional groups are arranged in a row on the second surface of the monomolecular layer, thereby forming covalent bonds with the surface of the fixing member body. The covalent bonds may be, for example, an —O— bond.

According to an embodiment, the organic silane-based compound may be represented by Formula 1:

SiR¹R²R³X, Formula 1

wherein, R¹ is a substituted or unsubstituted C₁-C₁₂ alkyl group, a substituted or unsubstituted C₂-C₁₂ alkenyl group, a substituted or unsubstituted C₂-C₁₂ alkynyl group, or a substituted or unsubstituted C₆-C₁₂ aryl group,

R² is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or a C₁-C₃ alkoxy group,

R³ is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or, a C₁-C₃ alkoxy group, and

X is a hydroxyl group, a halogen atom or a C₁-C₃ alkoxy group.

In an organic silane-based compound represented by Formula 1, a Si atom has at least 2 substituents (R¹ and X, and in this case, R² and R³ are hydrogen atoms), and has 4 substituents at most (R¹, R², R³ and X, provided that R² and R³ are not hydrogen atoms).

A substituent X bonds to the surface of the fixing member body, and form an “—O—” bond. Accordingly, the Si atom of the organic silane-based compound represented by Formula 1 is fixed on a substrate (hence, the surface of the fixing member body) through an “Si—O-substrate” bond.

In a monomolecular layer of the organic silane-based compounds represented by Formula 1, molecules of the organic silane-based compounds are densely arranged along the surface of the fixing member body. Here, each of the molecules of the organic silane-based compounds may be vertically oriented to the surface of the fixing member body.

Because the releasing layer is fixed on the surface of the fixing member body through a chemical bonding of substituent X of the organic silane-based compound, a fixing member according to an embodiment of the present general inventive concept does not require an adhesive agent to fix the releasing layer on the surface of the fixing member body.

The monomolecular layer of the organic silane-based compound represented by Formula 1 provides a hydrophobic surface through hydrophobic groups such as —CH₃ and —CF₃ located at a distal end of a substituent R¹. The hydrophobic surface provides effective releasability to the releasing layer including the monomolecular layer of the organic silane-based compounds represented by Formula 1. When a hydrophobic group exists at a distal end of substituents R² and/or R³, the substituents R² and/or R³ may also contribute to releasability of the monomolecular layer of the organic silane-based compounds represented by Formula 1.

In another embodiment of the fixing member, R² and/or R³, which are substituents of organic silane-based compounds represented by Formula 1, may be “—O—” bonds. In this case, a Si atom of one molecule of the organic silane-based compound represented by Formula 1 may connect to a Si atom of another nearby molecule of the organic silane-based compound via a “Si—O—Si” bond. Through a connection between molecules via the “Si—O—Si” bond, mechanical strength of the monomolecular layer of the organic silane-based compounds represented by Formula 1 may further improve and accordingly, abrasion resistance of a releasing layer may further improve. Furthermore, when the R² and/or R³, which are substituents of the organic silane-based compounds represented by Formula 1, are the “—O—” couplers, each molecule of the organic silane-based compounds in the monomolecular layer may have an improved vertical orientation with respect to a surface of a fixing member body. Accordingly, arrangement of molecules in the monomolecular layer becomes more dense and a hydrophobic surface, in which hydrophobic groups such as —CH₃ and —CF₃ are more densely arranged, is provided, thereby further improving releasability and anti-abrasiveness of the releasing layer.

In another embodiment of the fixing member, the releasing layer may include a plurality of monomolecular layers of organic-silane based compounds.

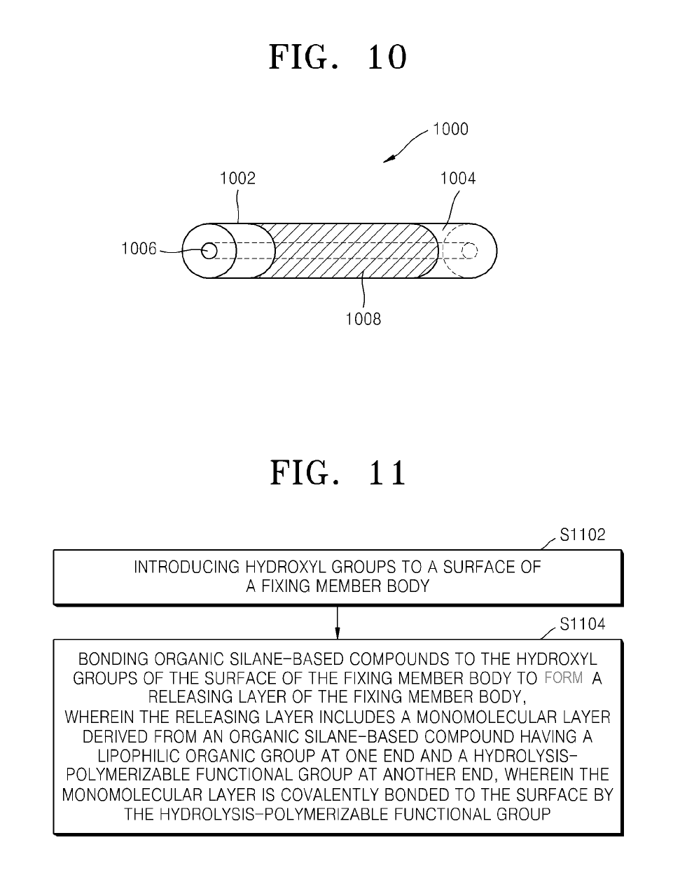

FIG. 11 is a flowchart illustrating a method of preparing a fixing member according to exemplary embodiments of the present general inventive concept. Particular operations of such a method are described below. That is, exemplary embodiments of the present general inventive concept may include the method of preparing a fixing member, including introducing hydroxyl groups to a surface of a fixing member body at operation S1102, and bonding organic silane-based compounds to the hydroxyl groups of the surface of the fixing member body to form a releasing layer of the fixing member body, wherein the releasing layer includes a monomolecular layer derived from an organic silane-based compound having a lipophilic organic group at one end and a hydrolysis-polymerizable functional group at another end, wherein the monomolecular layer is covalently bonded to the surface by the hydrolysis-polymerizable functional group at operation S1104.

The method of preparing a fixing member according to an embodiment of the present general inventive concept may include, introducing hydroxyl groups to a surface of a fixing member body and bonding organic silane-based compounds represented by Formula 1 to the hydroxyl groups of the surface of the fixing member body, thereby forming a releasing layer on the surface of the fixing member body,

wherein Formula 1 is represented by

SiR¹R²R³X,

wherein, R¹ is a substituted or unsubstituted C₁-C₁₂ alkyl group, a substituted or unsubstituted C₂-C₁₂ alkenyl group, a substituted or unsubstituted C₂-C₁₂ alkynyl group, or a substituted or unsubstituted C₆-C₁₂ aryl group,

R² is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or a C₁-C₃ alkoxy group,

R³ is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or, a C₁-C₃ alkoxy group, and

X is a hydroxyl group, a halogen atom or a C₁-C₃ alkoxy group.

The fixing member body may be in a form of, for example, a fixing roller, a fixing belt, a pressure roller, or a pressure belt. The fixing member body may include a heating means. The surface of the fixing member body refers to a surface contacting a recording paper during a fixing process. For example, the surface of the fixing member body may be an external surface of a cylindrical roller or an internal surface of a cylindrical belt. The surface of the fixing member body may be, for example, a metal or an elastic polymer. Materials of the surface of the fixing member body are not limited thereto, and may be any material in which a hydroxyl group may be formed.

Introducing hydroxyl groups to a surface of a fixing member body may include, for example, treating the surface of the fixing member body with ozone, hydroxide, or a mixture thereof. When ozone, hydroxide, or a mixture thereof reacts with the surface of the fixing member body, hydroxyl groups are introduced to the surface of the fixing member body. The hydroxyl group introduced to the surface of the fixing member body chemically bonds with the surface of the fixing member body. Specifically, the hydroxyl group introduced to the surface of the fixing member body covalently bonds with the surface of the fixing member body.

In another embodiment, introducing hydroxyl groups to a surface of a fixing member body may include irradiating vacuum ultraviolet (VUV) towards the surface of the fixing member body. The VUV may have a wavelength of about 100 nm to about 200 nm. Specifically, the VUV may have a wavelength of about 172 nm. The VUV may be irradiated by using an excimer lamp. The VUV gets absorbed into oxygen molecules and water molecules in the atmosphere and produces oxygen free radicals and hydroxides from the oxygen molecules and water molecules in the atmosphere. The oxygen free radicals produce ozone. The ozone and hydroxides chemically react with the surface of the fixing member body, thereby washing the surface of the fixing member body and introducing hydroxyl groups thereto.

The organic silane-based compounds represented by Formula 1 are bonded to hydroxyl groups of the surface of the fixing member body in order to form a releasing layer on the surface of the fixing member body.

In the organic silane-based compound represented by Formula 1, a Si atom has at least 2 substituents (R¹ and X, wherein R² and R³ are hydrogen atoms), and has 4 substituents (R¹, R², R³ and X, wherein R² and R³ are not hydrogen atoms) at most.

The substituent X may be, for example, a hydroxyl group, a halogen atom, or an alkoxy group. The alkoxy group may have, for example, a carbon number of 1 to 5. The substituent X bonds to a hydroxyl group bonded to the surface of the fixing member body. A bonding of the substituent X and the hydroxyl group on the surface of the fixing member body is based on a hydrolytic condensation. For example, when the substituent X is a hydroxyl group, the substituent X may directly bond to the hydroxyl group of the surface of the fixing member body. In another embodiment, when the substituent X is a halogen atom or an alkoxy group, the substituent X may be converted to a hydroxyl group and then bond to the hydroxyl group on the surface of the fixing member body. Due to a bond between X and the hydroxyl group on the surface of the fixing member body, a Si atom of the organic silane-based compound represented by Formula 1 is fixed on the substrate (i.e., the surface of the fixing member body) via the “Si—O-substrate” bond.

The organic silane-based compound represented by Formula 1 is fixed on the surface of the fixing member body via a chemical bond with the hydroxyl group on the surface of the fixing member body. The organic silane-based compounds represented by Formula 1 are densely arranged along the surface of the fixing member body through a direction of the hydroxyl groups on the surface of the fixing member body and an interaction between molecules of the organic silane-based compounds (for example, van der Waals forces). Here, each of the molecules of the organic silane-based compounds represented by Formula 1 may be vertically oriented to the surface of the fixing member body. Accordingly, a monomolecular layer of the organic silane-based compounds represented by Formula 1 is formed and fixed on the surface of the fixing member body. The monomolecular layer of the organic silane-based compounds represented by Formula 1 is the releasing layer.

Because the releasing layer is fixed on the surface of the fixing member body through a chemical bond between the substituent X of the organic silane-based compound and the hydroxyl group on the surface of the fixing member body, an adhesive agent is not required to fix the releasing layer on the surface of the fixing member body in an embodiment of the method provided in the present general inventive concept.

The monomolecular layer of the organic silane-based compound represented by Formula 1 provides a hydrophobic surface through hydrophobic groups such as —CH₃ and —CF₃ located at one end of R¹. The hydrophobic surface provides effective releasability to the releasing layer including the monomolecular layer of the organic silane-based compounds represented by Formula 1. When a hydrophobic group exists at an end of substituents R² and/or R³, the substituents R² and/or R³ may also contribute to releasability of the monomolecular layer of the organic silane-based compounds represented by Formula 1.

In another embodiment of the method of manufacturing the fixing member, R² and/or R³, which are substituents of organic silane-based compounds represented by Formula 1, may be hydrolysis-polymerizable functional groups. In this case, R² or R³ of one molecule of the organic silane-based compound, may bond to a R² or R³ of another molecule nearby, on the surface of the fixing member body. The bond is also a bond based on a hydrolytic polymerization. Accordingly, a Si atom of one molecule of the organic silane-based compound connects to a Si atom of another molecule of the organic silane-based compound nearby via a “Si—O—Si” bond. Through a connection between molecules via the “Si—O—Si” bond, mechanical strength of the monomolecular layer of the organic silane-based compounds represented by Formula 1 may improve further, and accordingly, abrasion resistance of a releasing layer may improve further. Furthermore, when the R² and/or R³, which are substituents of the organic silane-based compounds represented by Formula 1, are hydrolysis-polymerizable functional groups, each molecule of the organic silane-based compound in the monomolecular layer may have an improved vertical orientation with respect to the surface of a fixing member body. Accordingly, arrangement of molecules in the monomolecular layer becomes more dense, and a hydrophobic surface is provided in which hydrophobic groups such as —CH₃ and —CF₃ are more densely arranged, thereby further improving releasability and anti-abrasiveness of the releasing layer.

Bonding organic silane-based compounds represented by Formula 1 to the hydroxyl group on the surface of the fixing member body may be performed by, for example, a chemical vapor deposition (CVD). In another embodiment, bonding the organic silane-based compound represented by Formula 1 to a hydroxyl group of the surface of the fixing member body may include applying a solution including the organic silane-based compounds represented by Formula 1 to the surface of the fixing member body having the hydroxyl group, thereby forming a layer of the solution including the silane-based organic compounds represented by Formula 1; and heating the layer of the solution including the silane-based organic compounds represented by Formula 1. The solution including the organic silane-based compounds represented by Formula 1 may further include water to facilitate a reaction to form a bond based on a hydrolytic polymerization. The layer of the solution including the organic silane-based compounds represented by Formula 1 may be heated to catalyze the reaction to form a bond based on the hydrolytic condensation.

In another embodiment of the method of manufacturing the fixing member, introducing hydroxyl groups to a surface of a fixing member body, and bonding organic silane-based compounds represented by Formula 1 to the surface of the fixing member body, thereby forming a releasing layer on the surface of the fixing member body may be repeated multiple times. A releasing layer formed from the processes above may include a plurality of monomolecular layers of the organic silane-based compounds represented by Formula 1.

When the operation of introducing hydroxyl groups and the operation of bonding organic island-based compounds are repeated once, a monomolecular layer of the organic silane-based compounds represented by Formula 1 may exist on the surface of the fixing member body. Accordingly, when the operation of introducing hydroxyl groups and the operation of bonding organic island-based compounds are repeated once, the surface of the fixing member body is substituted with the surface of the monomolecular layer of the organic silane-based compounds represented by Formula 1. Similarly, hydroxyl groups may be introduced to the surface of the monomolecular layer of the organic silane-based compounds of Formula 1 by, for example, ozone and hydroxide treatments. Accordingly, the operation of introducing hydroxyl groups and the operation of bonding organic island-based compounds may be repeated.

Referring to FIG. 9, according to another embodiment of the present general inventive concept, a fixing device 912 includes a fixing roller or a fixing belt; and a pressure roller or a pressure belt arranged to rotate through engagement with the fixing roller or the fixing belt, wherein at least one of the fixing roller, the fixing belt, the pressure roller, and the pressure belt may include a fixing member provided in accordance with the present general inventive concept.

Also, referring to FIG. 9, according to another embodiment of the present general inventive concept, an image forming apparatus 914 having a fixing device 912 including a fixing roller or a fixing belt 916, and a pressure roller or a pressure belt 918 are arranged to rotate through engagement with the fixing roller or the fixing belt 916, wherein at least one of the fixing roller or the fixing belt 916, and the pressure rolleror the pressure belt 918 may include a fixing member 910 provided in accordance with the present general inventive concept.

### EXAMPLE

In the present Example, a FAS-17 (heptadecafluoro-1,1,2,2-tetrahydrodecyltrimethoxysilane) monomolecular layer was formed on a glass substrate. First, VUV having a wavelength of 172 nm was irradiated for 30 minutes towards the glass substrate in air to introduce hydroxyl groups to the glass substrate.

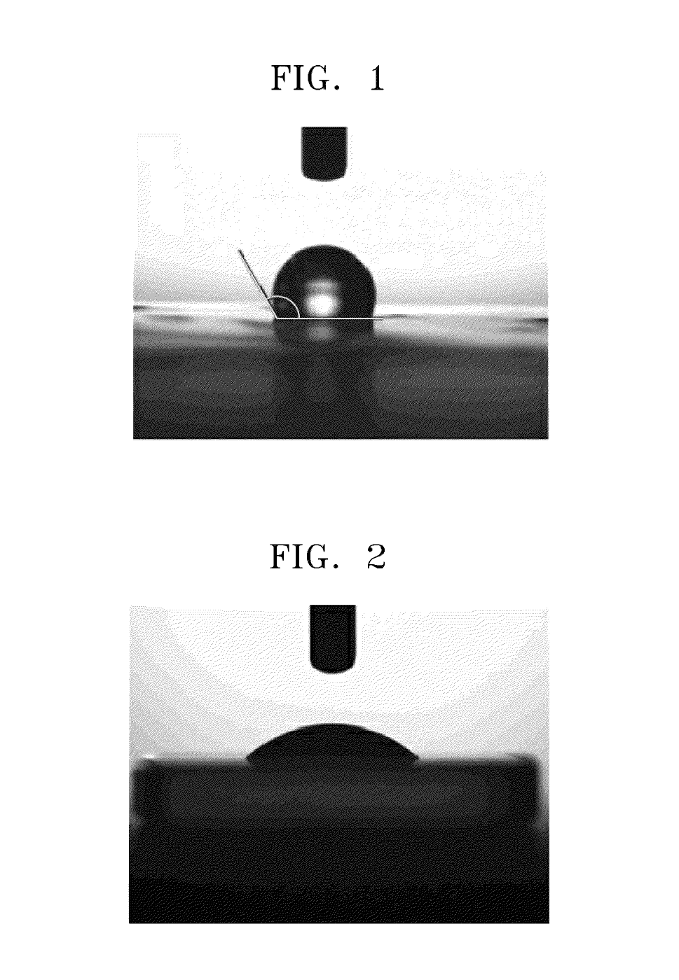

FIG. 1 illustrates results of measuring a water contact angle of perfluoroalkoxy (PFA), which is commonly used as a conventional releasing layer. A surface having a large water contact angle (for example, 90° or greater) may be referred to as a hydrophobic surface. It is difficult to attach materials on the hydrophobic surface. In other words, the hydrophobic surface may be a surface from which attachments may be easily detached. Accordingly, the greater the contact angle, the better the releasability. As illustrated in FIG. 1, a water contact angle of a PFA surface is 111.2° and thus, it may be deduced that the PFA surface has effective releasability.

FIG. 2 illustrates a water contact angle of a surface of an untreated glass substrate. The surface of the untreated glass substrate has a water contact angle of 43.2° and thus, it may be deduced that the untreated glass substrate is hydrophilic (90° or less). Materials may be easily attached to the hydrophilic surface, and thus, the hydrophilic surface has poor releasability.

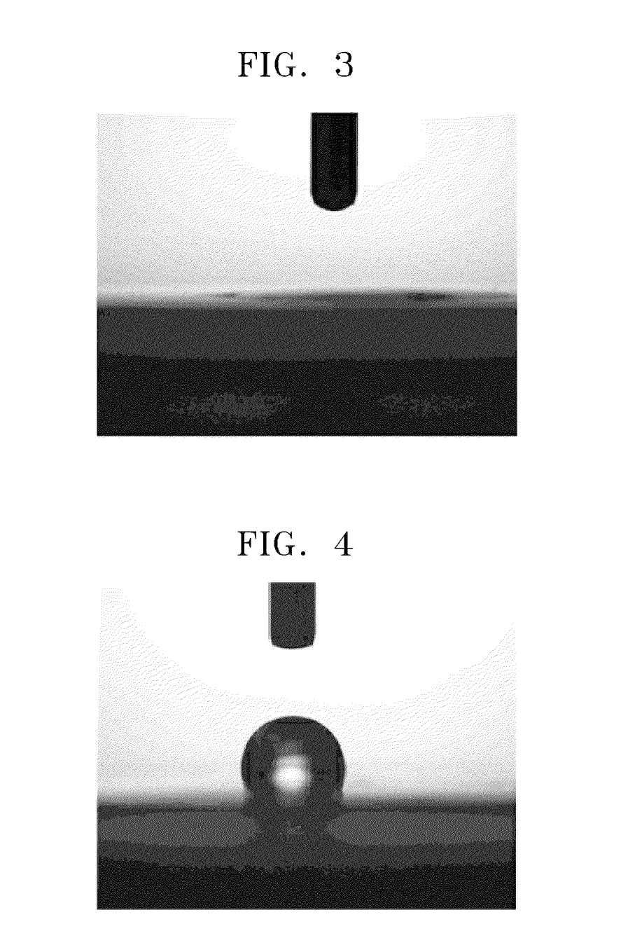

FIG. 3 illustrates a water contact angle of a surface of a glass substrate in which hydroxyl groups are introduced. The surface of the glass substrate in which hydroxyl groups are introduced shows ultrahydrophilicity. From this, it may be deduced that the hydroxyl groups are effectively introduced to the surface of the glass substrate treated with VUV.

Then, chemical vapor deposition (CVD) was used to deposit heptadecafluoro-1,1,2,2-tetra-hydrodecyltrimethoxysilane (FAS-17) on the surface of the glass substrate in which the hydroxyl groups are introduced, thereby forming a FAS-17 monomolecular layer on the surface of the glass substrate in which the hydroxyl groups are introduced.

FIG. 4 illustrates a water contact angle of a surface of a FAS-17 monomolecular layer formed on a surface of a glass substrate. A water contact angle of the surface of the FAS-17 monomolecular layer is 111.6° and the surface of the FAS-17 monomolecular layer has hydrophobicity and effective releasability. Because a FAS-17 molecule has a —CF₃ group at an end of an organic substituent, the FAS-17 monomolecular layer shows very effective releasability.

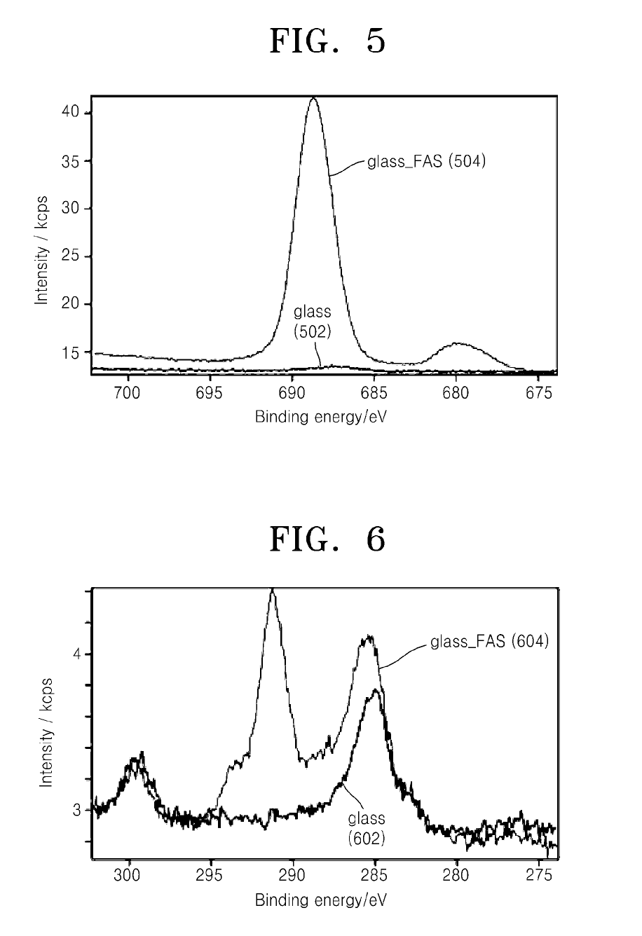

FIG. 5 illustrates results of XPS F1s measured by using an X-ray photoelectron spectroscopy (XPS) on a surface of an untreated glass substrate and a surface of a FAS-17 monomolecular layer formed on a glass substrate. The surface of the untreated glass substrate did not show XPS peaks 502 corresponding to a —CF₃ group and a —CF₂ group. In contrary, the surface of the FAS-17 monomolecular layer formed on the glass substrate showed XPS peaks 504 corresponding to the —CF₃ group and the —CF₂ group very effectively.

FIG. 6 illustrates results of XPS C1s measured on a surface of a FAS-17 monomolecular layer formed on a surface of a glass substrate and an untreated glass substrate. The surface of the untreated glass substrate did not show XPS peaks 602 corresponding to a —CF₃ group and a —CF₂ group. In contrast, the surface of the FAS-17 monomolecular layer formed on the glass substrate showed XPS peaks 604 corresponding to the —CF₃ group and the —CF₂ group very effectively.

It may be deduced from FIGS. 5 and 6 that the FAS-17 monomolecular layer having —CF₃ groups was formed on the glass substrate.

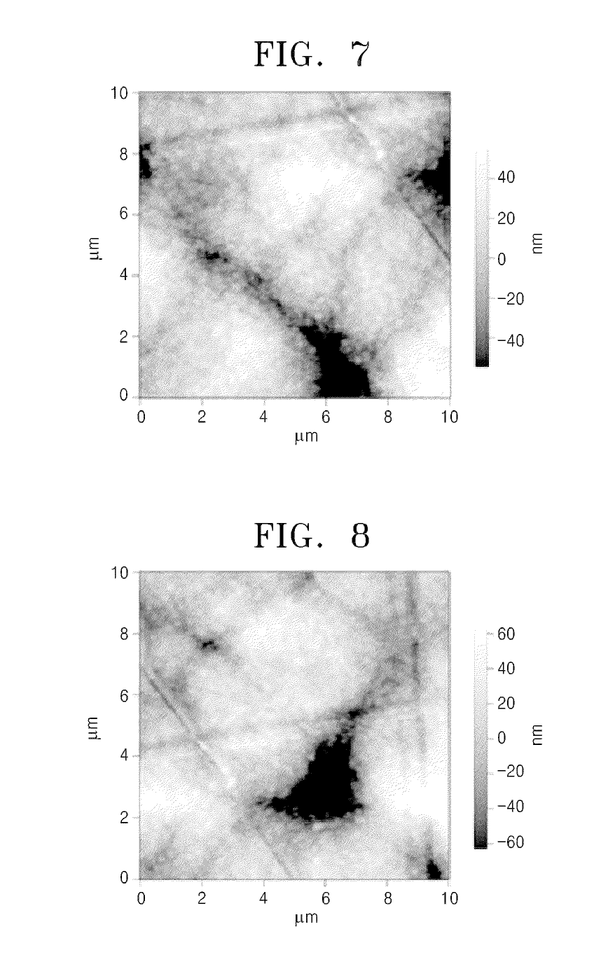

FIG. 7 illustrates results of atomic force microscope (AFM) analysis of a surface of an untreated glass substrate. FIG. 8 illustrates results of atomic force microscope (AFM) analysis performed on a surface of a FAS-17 monomolecular layer formed on a glass substrate. Roughness of a surface may be measured through the AFM analysis.

Root mean square (RMS) values in FIGS. 7 and 8 are 30.1 nm and 31.2 nm, respectively, and thus, the RMS values do not show a great difference and are minimal. From this, it may be deduced that the glass substrate has a very uniform and even surface and that a self-organizing monomolecular layer is also uniformly and evenly formed on the glass substrate. Also, the results show that the self-organizing monomolecular layer has very elevated density and orientation.

An organic silane-based compound having a lipophilic organic group at one end and a hydrolysis-polymerizable functional group at another end may form a self-organizing monomolecular layer. The monomolecular layer derived from the organic silane-based compound may form a chemical covalent bond with a surface of any material such as a metal oxide, a metal, glass, a silicon rubber, and a polymer, to which OH groups (hydroxyl groups) may be introduced, and thus, the monomolecular layer may have an elevated adhesive strength with respect to a fixing member body. Also, orientation of organic silane-based compound molecules in the monomolecular layer is effective due to interactions between the organic silane-based compound molecules. Accordingly, lipophilic organic groups of the organic silane-based compounds are arranged in a row on a surface of the monomolecular layer. Accordingly, releasability of the surface of the monomolecular layer is effective. Also, the monomolecular layer has the orientation of organic silane-based molecules and is a membrane formed in a self-organizing manner, thereby providing a very uniform and even membrane.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fixing member, comprising:
a fixing member body having a surface; and
a releasing layer fixed on the surface, wherein the releasing layer comprises a monomolecular layer derived from an organic silane-based compound having a lipophilic organic group at one end and a hydrolysis-polymerizable functional group at another end, and the monomolecular layer is covalently bonded to the surface by the hydrolysis-polymerizable functional group.

2. The fixing member of claim 1, wherein the lipophilic organic group comprises hydrophobic groups such as —CH₃ and —CF₃.

3. The fixing member of claim 1, wherein the hydrolysis-polymerizable functional group comprises a hydroxyl group, a halogen atom, or an alkoxy group.

4. The fixing member of claim 1, wherein the releasing layer comprises a plurality of monomolecular layers of organic silane-based compounds.

5. The fixing member of claim 1, further including a heat unit.

6. The fixing member of claim 1, wherein the surface of the fixing member body is a hydroxyl group-forming material.

7. The fixing member of claim 1, wherein the organic silane-based compound is represented by Formula 1:
SiR¹R²R³X, Formula 1
wherein R¹ is a substituted or unsubstituted C₁-C₁₂ alkyl group, a substituted or unsubstituted C₂-C₁₂ alkenyl group, a substituted or unsubstituted C₂-C₁₂ alkynyl group, or a substituted or unsubstituted C₆-C₁₂ aryl group,
R² is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or a C₁-C₃ alkoxy group,
R³ is a hydrogen atom, a substituted or unsubstituted C₁-C₁₂ alkyl group, a substituted or unsubstituted C₂-C₁₂ alkenyl group, a substituted or unsubstituted C₂-C₁₂ alkynyl group, a substituted or unsubstituted C₆-C₁₂ aryl group, a hydroxyl group, a halogen atom, or, C₁-C₃ alkoxy group, and
X is a hydroxyl group, a halogen atom, or a C₁-C₃ alkoxy group.

8. The fixing member of claim 7, wherein at least one of R² and R³, which are substituents of an organic silane-based compound represented by Formula 1, is a hydrolysis-polymerizable functional group.

9. The fixing member of claim 7, wherein the Si atom of the organic silane-based compound represented by Formula 1 has at least two substituents R¹ and X, and R² and R³ of Formula 1 are hydrogen atoms.

10. The fixing member of claim 7, wherein the Si atom of the organic silane-based compound represented by Formula 1 has four substituents R¹, R², R³, and X, and wherein substituents R² and R³ of Formula 1 are not hydrogen atoms.

11. The fixing member of claim 7, wherein the substituent X is bonded to the surface of the fixing member to form an —O— bond, and at least one Si atom of the organic silane-based compound represented by Formula 1 is fixed on a substrate through a Si—O-substrate bond.

12. The fixing member of claim 7, wherein a hydrophobic group is located at a distal end of at least one of substituents R² and R³ of Formula 1.

13. The fixing member of claim 7, wherein at least one of substituents R² and R³ of Formula 1 forms an —O— bond, and at least a first Si-atom of a first molecule of the organic silane-based compound represented by Formula 1 connects to another Si atom of a second proximate molecule of the organic silane-based compound via a Si—O—Si bond.

14. A fixing device comprising:
a fixing roller or a fixing belt; and
a pressure roller or a pressure belt arranged to rotate through engagement with the fixing roller or the fixing belt,
wherein at least one of the fixing roller, the fixing belt, the pressure roller, and the pressure belt comprises a fixing member, wherein the fixing member comprises:
a fixing member body having a surface; and
a releasing layer fixed on the surface,
wherein the releasing layer comprises a monomolecular layer derived from an organic silane-based compound having a lipophilic organic group at one end and a hydrolysis-polymerizable functional group at another end, and the monomolecular layer is covalently bonded to the surface by the hydrolysis-polymerizable functional group.

15. An image forming apparatus having a fixing device comprising:
a fixing roller or a fixing belt; and
a pressure roller or a pressure belt arranged to rotate through engagement with the fixing roller or the fixing belt,
wherein at least one of the fixing roller, the fixing belt, the pressure roller, and the pressure belt comprises a fixing member, wherein the fixing member comprises:
a fixing member body having a surface; and
a releasing layer fixed on the surface,
wherein the releasing layer comprises a monomolecular layer derived from an organic silane-based compound having a lipophilic organic group at one end and a hydrolysis-polymerizable functional group at another end, and the monomolecular layer is covalently bonded to the surface by the hydrolysis-polymerizable functional group.
